(19) United States
(12) Patent Application Publication
(10) Pub. No.: US 2026/0311556 A1
(43) Pub. Date: Oct. 8, 2026

(54) GAMING ESTABLISHMENT FUND TRANSFERS BASED ON USER ACTIVITIES

(71) Applicant: IGT, Las Vegas, NV (US)

(72) Inventors: Jeffery Shepherd, Reno, NV (US); Kevin Higgins, Reno, NV (US)

(21) Appl. No.: 19/098,655

(22) Filed: Apr. 2, 2025

(51) Int. Cl. G07F 17/32

(52) U.S. Cl. CPC G07F 17/3244

(57) ABSTRACT

Responsive to a first gaming establishment activity associated with a user occurs at a first point in time, a system determines, based on the first gaming establishment activity, a first account from a plurality of gaming establishment accounts associated with the user, and causes a transfer of funds associated with at least one of the plurality of gaming establishment accounts other than the first account to the determined first gaming establishment account. Responsive to a second gaming establishment activity associated with the user occurring at a second, subsequent point in time, the system determines whether a second account associated with the second gaming establishment activity is different from the first account, and responsive to the determination being that the second account is different from the first account, causes a transfer of funds associated with at least one of the plurality of gaming establishment accounts to the second account.

### BACKGROUND

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIG. 2 is a schematic diagram of the interactions between different components associated with an electronic gaming machine, a plurality of cashless wagering systems of multiple gaming establishment sites and a database pertaining to fund coalescence events to execute a consolidation of funds upon an occurrence of a fund coalescence event.

### DETAILED DESCRIPTION

In various embodiments, the systems and methods of the present disclosure determine, responsive to a first gaming establishment activity associated with a user occurring at a first point in time and based on the first gaming establishment activity, a first gaming establishment account from a plurality of gaming establishment accounts associated with the user, and cause a transfer of funds associated with at least one of the plurality of gaming establishment accounts other than the first gaming establishment account to the determined first gaming establishment account. In these embodiments, responsive to a second gaming establishment activity associated with the user occurring at a second, subsequent point in time, the systems and methods determine whether a second gaming establishment account associated with the second gaming establishment activity is different from the first gaming establishment account, and if so, cause a transfer of funds associated with at least one of the plurality of gaming establishment accounts to the second gaming establishment account.

In certain embodiments, in view of the computational resources required to present a single aggregate balance of multiple, independently maintained gaming establishment accounts associated with multiple gaming establishments, the systems and methods of the present disclosure route funds to an actively engaged gaming establishment account to alleviate various computational stresses associated with presenting such a single aggregate balance. In certain additional or alternative embodiments, the systems and methods of the present disclosure route funds from different independently maintained gaming establishment accounts to a gaming establishment account anticipated to be actively engaged. In certain such embodiments, whether the system relies on active engagement and/or anticipated engagement to determine a destination gaming establishment account, the system routes funds from different independently maintained gaming establishment accounts to the determined destination gaming establishment account. In certain other embodiments, whether the system relies on active engagement and/or anticipated engagement to determine a destination gaming establishment account, the system routes funds from an external account to the determined destination gaming establishment account. As such, the system intelligently routes funds to a dynamically determined destination gaming establishment account to minimize or eliminate the need to dedicate computing resources to relatively frequently run queries on balances of different gaming establishment accounts at different gaming establishment sites. This intelligent routing of funds enables the system to present a user with a single balance of funds available while saving computing resources in the process. Put differently, since: (i) gaming establishment accounts are distributed in multiple locations in a multiple-site installation, (ii) users may, at any given time, hold funds in multiple gaming establishment accounts, and (iii) it is computationally and transactionally stressful, from a computing performance perspective, each time the system interacts with different gaming establishment components that maintain these different gaming establishment accounts, the system of the present disclosure operates to, in certain instances, consolidate funds from multiple, disparate gaming establishment accounts to a single, dynamically determined destination gaming establishment account (which may change at different points in time). Such a consolidation of funds reduces the quantity of account balance queries associated with the system and thus result in a more efficiently operating system (relative to prior systems that dedicated significant computing resources to account balance inquiries).

In certain embodiments, in determining a destination gaming establishment account to route funds to, the system employs a location of a user. In these embodiments, upon an occurrence of a fund coalescence event, the system determines a location of a user and routes funds to a gaming establishment account associated with the determined location of the user. For example, upon a user logging into an electronic gaming machine (“EGM”) of a gaming establishment (i.e., an occurrence of a fund coalescence event), the system determines a location of the EGM which the user logged into and routes funds from one or more gaming establishment accounts associated with one or more other locations to a gaming establishment account associated with the gaming establishment of the logged into EGM. In another example, upon a user initiating a transfer of funds from an external account (i.e., an occurrence of a fund coalescence event), the system determines a location of the user and routes funds from the external account to a gaming establishment account associated with a gaming establishment where that user is located.

In certain additional or alternative embodiments, in determining a destination gaming establishment account to route funds to, the system employs prior gaming establishment account activity. In these embodiments, upon an occurrence of a fund coalescence event, the system determines which gaming establishment account a user last transacted against (or last transacted against within a designated period of time) and routes funds to the determined gaming establishment account. In certain additional or alternative embodiments, in determining a destination gaming establishment account to route funds to, the system employs prior fund transfer activity. In these embodiments, upon an occurrence of a fund coalescence event, the system determines which gaming establishment account a user last transferred funds to (or last transferred funds to within a designated period of time) and routes funds to the determined gaming establishment account. In certain additional or alternative embodiments, in determining a destination gaming establishment account to route funds to, the system employs a user designation. In these embodiments, upon an occurrence of a fund coalescence event, the system determines a gaming establishment account associated with a user designation (e.g., has the user designated a gaming establishment site as a home site such that a gaming establishment account associated with that gaming establishment site qualifies as a default gaming establishment account) and routes funds to the user designated gaming establishment account. In certain additional or alternative embodiments, in determining a destination gaming establishment account to route funds to, the system employs non-designated user data. In these embodiments, upon an occurrence of a fund coalescence event, the system determines a gaming establishment account associated with that user data (e.g., a gaming establishment site near the user's home (as determined by interfacing with a gaming establishment patron management system) qualifies as a home site such that the destination gaming establishment account defaults to a gaming establishment account associated with that gaming establishment site) and routes funds to that gaming establishment account.

In certain additional or alternative embodiments, in determining a destination gaming establishment account to route funds to, the system employs prior gaming establishment activity. In these embodiments, upon an occurrence of a fund coalescence event, the system determines which gaming establishment activity a user last engaged in (or last engaged in within a designated period of time), then determines a gaming establishment account associated with that prior gaming establishment activity and then routes funds to the determined gaming establishment account. For example, upon a user logging into an EGM of a gaming establishment (i.e., an occurrence of a fund coalescence event), the system determines that the user last engaged in sporting event wagering activity. In this example, the system routes funds from one or more non-sports wagering gaming establishment accounts associated with the user to a sports wagering gaming establishment account associated with the user.

In certain additional or alternative embodiments, in determining a destination gaming establishment account to route funds to, the system employs anticipated user activity. In these embodiments, upon an occurrence of a fund coalescence event, the system determines a gaming establishment account associated with the anticipated user activity and routes funds to the gaming establishment account associated with the anticipated user activity. For example, upon a determination that a user will soon visit a gaming establishment (i.e., an occurrence of a fund coalescence event), the system determines a gaming establishment account associated with the user at the gaming establishment which the user plans to visit and routes funds (from one or more other gaming establishment accounts and/or an external account) to the gaming establishment account associated with the gaming establishment the user plans on visiting. In certain additional or alternative embodiments, in determining a destination gaming establishment account to route funds to, the system employs anticipated gaming establishment account activity. In these embodiments, upon an occurrence of a fund coalescence event, the system determines which gaming establishment account a user is anticipated to transact against and routes funds to the gaming establishment account anticipated to be transacted against. In certain additional or alternative embodiments, in determining a destination gaming establishment account to route funds to, the system employs anticipated gaming establishment activity. In these embodiments, upon an occurrence of a fund coalescence event, the system determines which gaming establishment activity a user is anticipated to engage in, determines a gaming establishment account associated with that anticipated gaming establishment activity and then routes funds to the determined gaming establishment account. For example, upon a user logging into a gaming establishment device (i.e., an occurrence of a fund coalescence event), the system anticipates that the user will undertake sporting event wagering, determines a sports wagering account of the user and routes funds to that determined sports wagering account.

It should be appreciated that since, in certain instances, a user is associated with multiple gaming establishment accounts affiliated with multiple gaming establishments, as the user accesses these different gaming establishment accounts over different periods of time, the destination gaming establishment account varies over such different periods of time. That is, rather than simply consolidating funds to a primary gaming establishment account to ease balance inquiries on the system, the system dynamically employs, at different points in time, different gaming establishment accounts which funds are individually consolidated in to ease balance inquiries on the system and/or the need to interface with multiple components of multiple gaming establishment systems for certain transactions to occur. For example, if a user at a gaming establishment device (e.g., a non-gaming device, such as a retail point-of-sale terminal or a gaming device, such as an EGM or a gaming table component associated with a gaming establishment gaming table) of a first gaming establishment at which the user is associated with a first gaming establishment account requests to view an aggregate balance of funds (which are held across multiple gaming establishment accounts), and if the system determines that the last fund coalescence event occurred in association with a second, different gaming establishment account associated with a second, different gaming establishment (and/or determines that the last fund coalescence event occurred more than a predefined amount of time ago), the system causes a fund coalescent event to occur in association with the first gaming establishment account (thus changing which gaming establishment account qualifies as the destination gaming establishment account). As illustrated by this example, the system employs multiple destination gaming establishment accounts (which funds are consolidated into) over different periods of time to account for the movement of users across different gaming environments while still reducing operational stresses otherwise associated with interfacing with these different gaming environments to determine an amount of funds held in these different gaming establishment accounts.

It should be further appreciated that since, in certain instances, a user is associated with multiple gaming establishment accounts affiliated with one or more gaming establishments and different gaming establishment verticals (e.g., wagering at a gaming establishment device, wagering associated with a gaming establishment but occurring remote from a gaming establishment device, and gaming establishment retail transactions) of these one or more gaming establishments, as the user accesses these different gaming establishment accounts over different periods of time, the destination gaming establishment account varies over such different periods of time. In other words, the system of certain embodiments of the present disclosure dynamically employs, at different points in time and based on different user historical behavior (e.g., which gaming establishment verticals a user previously engaged in) and/or different anticipated user behavior (e.g., which gaming establishment verticals is a user anticipated to engage in), different gaming establishment accounts which funds are individually consolidated in to ease balance inquiries on the system and/or the need to interface with multiple components for certain transactions to occur. As such, the system employs multiple destination gaming establishment accounts (which funds are consolidated into) over different periods of time to account for different user behavior (e.g., different gaming establishment verticals accessed) while still reducing operational stresses otherwise associated with interfacing with components that maintain these different gaming establishment accounts in determining any amounts of funds held in these different gaming establishment accounts.

In certain embodiments, the system employs the coalescence of funds from multiple different gaming establishment accounts into a dynamically determined gaming establishment account to reduce operational stresses via eliminating the need to interface with multiple different components that maintain multiple different gaming establishment accounts. In certain such embodiments, when a user requests to view a balance of funds held across multiple gaming establishment accounts, if the system determines that funds from these multiple gaming establishment accounts have been recently coalesced, the system determines that no other computing components that maintain any other gaming establishment accounts need to be queried for the balance information. Continuing with the above example, if the system determines that the last fund coalescence event occurred in association with the first gaming establishment account within the predefined amount of time, such a determination informs the system that funds from other gaming establishment accounts associated with the user have recently been consolidated into the first gaming establishment account. Aware that funds have already been transferred to the first gaming establishment account enables the system to save processing resources and speed up system operations by bypassing any balance information queries of other gaming establishment accounts. In certain other embodiments, when a user requests to transfer funds to a destination, such as to a gaming establishment device, if the system determines that funds from multiple gaming establishment accounts associated with the user have recently been coalesced, the system determines that no other computing components that maintain any other gaming establishment accounts need to be transacted against to transfer funds from (i.e., all the funds held in the various gaming establishment accounts associated with the user have already been transferred to a dynamically determined gaming establishment account) enabling the system to save processing resources by not having to inquire into any availability of any funds held in any other gaming establishment accounts prior to determining whether to authorize the transfer of funds to the destination.

Such a configuration of consolidating funds from one or more gaming establishment accounts to a dynamically determined gaming establishment account limits the quantity of gaming establishment accounts which need to be accessed for subsequent balance inquiries and/or requested fund transfers and thus alleviates the quantity of transactions the system needs to perform to accomplish such balance inquiries and/or such requested fund transfers. Such a configuration of routing funds from an external account to a dynamically determined gaming establishment account further limits the quantity of subsequent transfers of funds needed (e.g., if the funds from the external account are transferred to a first gaming establishment account only to then be transferred to a second gaming establishment account) and thus alleviates the quantity of transactions the system needs to perform. Put differently, utilizing different dynamically determined gaming establishment accounts as temporary repositories of funds results in less system transactions needing to occur between different components of one or more gaming establishments to accomplish a user's objective to view a aggregate balance and/or transact against funds otherwise held across multiple gaming establishment accounts (thus increasing system efficiency by reducing the need to request balance information against multiple gaming establishment accounts and/or execute multiple transactions against multiple gaming establishment accounts to obtain the same funding).

In various embodiments, the system of the present disclosure operates as a gaming establishment fund management system including various sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) at one or more entities (e.g., one or more gaming establishment sites) and gaming establishment retail accounts (e.g., gaming establishment retail wallets) at one or more entities (e.g., one or more gaming establishment sites) which are each associated with or otherwise maintained for a user, such as a retail patron, collectively form a resort or enterprise account (i.e., an integrated resort or gaming establishment fund management wallet) that the user may access to transfer funds and/or view balance information amongst the various accounts associated with or otherwise maintained for the user.

It should be appreciated that while generally described in the present disclosure as one or more gaming establishment accounts, such as cashless wagering accounts and/or gaming establishment retail accounts, being associated with an entity comprising an individual gaming establishment site, in certain other embodiments, an entity associated with one or more gaming establishment accounts, such as cashless wagering accounts and/or gaming establishment retail accounts, comprises a plurality of gaming establishment sites. In these embodiments, one or more gaming establishment accounts are associated with a corporate entity and various children entities (i.e., zero, one or more gaming establishment brands and zero, one or more gaming establishment venues having one or more EGMs and/or being associated with one or more personal gaming devices) that are associated with that corporate entity. In these embodiments, a gaming establishment venue includes a single property where an EGM may operate, a gaming establishment brand includes a group of gaming establishment venues under a single brand, and a corporate entity includes a group of one or more gaming establishment brands and/or a group of one or more gaming establishment venues. As such, zero, one or more gaming establishment accounts available to operate as a destination gaming establishment are associated with a single gaming establishment site and zero, one or more gaming establishment accounts available to operate as a destination gaming establishment are associated with a group of gaming establishment sites.

In various embodiments, the gaming establishment fund management system includes or is otherwise associated with one or more cashless wagering systems. In certain embodiments, one or more cashless wagering systems are single site capable in that the cashless wagering system is associated with or otherwise maintains one or more cashless wagering accounts per gaming establishment site. In certain embodiments, one or more cashless wagering systems are multi-site capable in that the cashless wagering system is associated with or otherwise maintains one or more cashless wagering accounts for a plurality of gaming establishment sites.

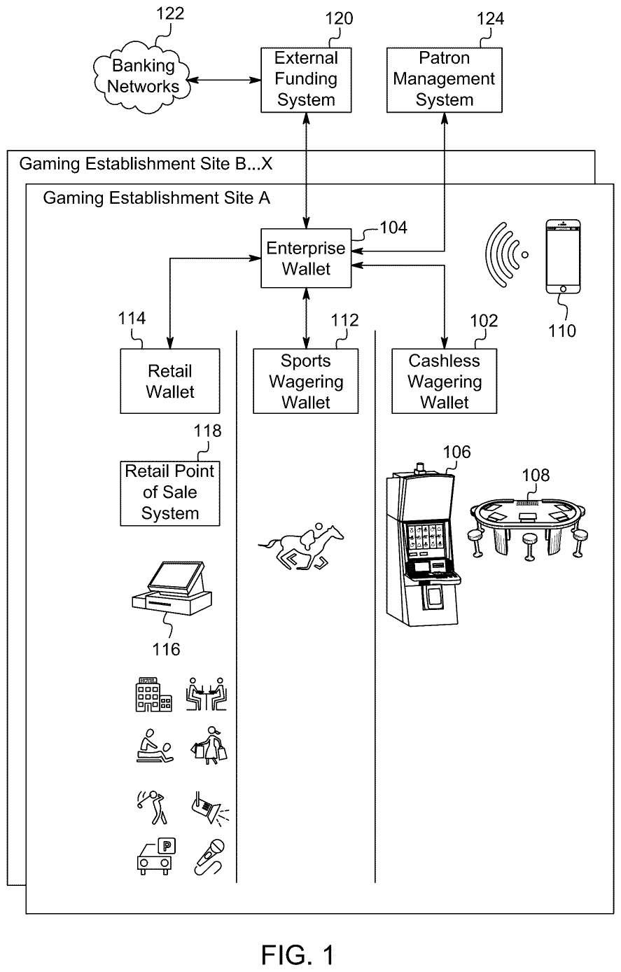

In certain embodiments, the gaming establishment fund management system includes or is otherwise in communication with one or more first cashless wagering systems that each maintains a first cashless wagering account. In these embodiments, a user, such as a player of an EGM, utilizes a mobile device application running on a mobile device and/or a physical instrument (e.g., a smart card or a user issued magnetic striped card which the user utilizes via inserting the card into a component of a gaming establishment patron management system associated with a gaming establishment device) to facilitate the electronic transfer of any funds between this first cashless wagering account and a gaming establishment device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system of each gaming establishment site includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account. In certain embodiments, as illustrated in FIG. 1, the system includes or is otherwise associated with one or more first cashless wagering systems per gaming establishment site. In certain embodiments, the system includes or is otherwise associated with one or more first cashless wagering systems associated with multiple gaming establishment sites. In these embodiments, the system maintains a first cashless wagering system deployed as single application employed to handle wagering transactions at an EGM and/or at a gaming table across a variety of gaming establishment sites.

In certain embodiments, the gaming establishment fund management system additionally or alternatively includes or is otherwise in communication with one or more second cashless wagering systems that each maintains a second cashless wagering account. In these embodiments, funds associated with certain second cashless wagering accounts are utilized to place one or more sporting event wagers and funds associated with other second cashless wagering accounts are utilizes to place one or more wagers remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between these second cashless wagering accounts and a credit balance accessible to wager on sporting events and/or games of chance (or games of skill) remote from an EGM and a gaming table. For example, as seen in FIG. 1, the gaming establishment fund management system of each gaming establishment site includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account. In certain embodiments, as illustrated in FIG. 1, the gaming establishment fund management system includes or is otherwise associated with one or more second cashless wagering systems per gaming establishment site. In certain embodiments, the gaming establishment fund management system includes or is otherwise associated with one or more second cashless wagering systems associated with multiple gaming establishment sites. In these embodiments, the system maintains a second cashless wagering system deployed as single application employed to handle sporting event wagering transactions and/or wagering transactions placed remote from an EGM and remote from a gaming table across a variety of gaming establishment sites.

In various embodiments, in addition to or an alternative of maintaining one or more cashless wagering accounts via one or more cashless wagering systems, the gaming establishment fund management system includes or is otherwise in communication with one or more gaming establishment retail wallet systems that each maintain one or more gaming establishment retail accounts. In certain embodiments, one or more gaming establishment retail wallet systems are single site capable in that the gaming establishment retail wallet system is associated with or otherwise maintains one or more gaming establishment retail accounts per gaming establishment site. In certain embodiments, one or more gaming establishment retail wallet systems are multi-site capable in that the gaming establishment retail wallet system is associated with or otherwise maintains one or more gaming establishment retail accounts for a plurality of gaming establishment sites. In different embodiments, one or more gaming establishment retail accounts are each operable to hold different types of instruments exchangeable for goods and/or services, such as, but not limited to, an amount of monetary funds, an amount of non-monetary funds (e.g., non-cashable promotional credits, promotional credits) and/or one or more coupons.

In certain embodiments, a gaming establishment retail account (e.g., a gaming establishment retail wallet) of a gaming establishment retail wallet system integrates with various retail point-of-sale systems throughout one or more gaming establishments (or located remote from such gaming establishments, but otherwise associated with such gaming establishments) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In certain embodiments, the gaming establishment fund management system utilizes the gaming establishment retail wallet system as a transaction coordinator to account for any transactions to purchase goods and/or services from a retailer. In certain embodiments, as illustrated in FIG. 1, the gaming establishment fund management system includes or is otherwise associated with one or more gaming establishment retail wallet systems per gaming establishment site. In certain embodiments, the gaming establishment fund management system includes or is otherwise associated with one or more gaming establishment retail wallet systems associated with multiple gaming establishment sites. In these embodiments, the system maintains a gaming establishment retail wallet system deployed as single application employed to handle retail transactions across a variety of gaming establishment sites.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, the gaming establishment fund management system includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIG. 1, the gaming establishment fund management system that maintains the enterprise wallets per gaming establishment site is in communication with a payment gateway (i.e., external funding system 120) that services each of the gaming establishment sites and which is in communication with a network of one or more banks or other financial institutions (i.e., the banking networks 122) that operate to electronically transfer funds between the user's accounts maintained at such banks or financial institutions between one or more of the accounts at one or more of the gaming establishment sites maintained by the gaming establishment fund management system. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that any component or sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise in communication with one or more gaming establishment patron management systems, such as one or more player tracking systems, operating per gaming establishment site or operating for a plurality of gaming establishment sites. Such gaming establishment patron management systems maintain data associated with one or more users, monitor activities at various points of contact associated with one or more gaming establishment sites and provides rewards, such as redeemable player tracking points, to such users in association with the monitored activities. For example, as seen in FIG. 1, the gaming establishment fund management system that maintains the enterprise wallet 104 is in communication with a patron management system 124 which maintains one or more databases including information regarding gaming establishment patrons. It should be appreciated that any component or sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the gaming establishment fund management system includes or is otherwise in communication with one or more credit systems operating per gaming establishment site or operating for a plurality of gaming establishment sites. Such credit systems issue the user one or more lines of credit or markers. In certain embodiments, these lines of credit or markers are accessible to facilitate a transfer of funds from the line of credit issued by the credit system to, either directly or indirectly through a cashless wagering account, a credit balance of a gaming establishment device, such as an EGM and/or a gaming table. In this example, to facilitate a transfer of funds from the line of credit issued by the credit system to a credit balance of an EGM and/or a gaming table, the system utilizes a mobile device running a mobile device application that interfaces with one or more components of the credit system to enable a user, such as a player of the EGM or a player at the gaming table, access to the issued line of credit. In certain embodiments, these lines of credit or markers are additionally or alternatively accessible to facilitate a transfer of funds from the line of credit issued by the credit system to, either directly or indirectly through a cashless wagering account, a balance of a gaming establishment retail account to facilitate a gaming establishment retail transaction. It should be appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments, the gaming establishment fund management system includes or is otherwise in communication with one or more credit reporting/credit risk systems operating per gaming establishment site or operating for a plurality of gaming establishment sites. Such credit reporting/credit risk systems monitor and report on various accounts associated with the user. These credit reporting and risk systems monitor and report on a credit rating and status of one or more accounts maintained for the user at various funding sources, such as various financial institutions.

In certain embodiments, the gaming establishment fund management system includes or is otherwise in communication with one or more front money handling systems operating per gaming establishment site or operating for a plurality of gaming establishment sites. Such front money handling systems maintain an amount of front money provided by a user in a front money account. For example, the gaming establishment fund management system that maintains the enterprise wallet is in communication with a gaming establishment front money handling system to facilitate the access of an amount of funds via front money provided by the user. Such front money is provided by the user, such as via the user depositing cash, gaming table chips, a personal check, a bank draft, a money order or a wire transfer into a front money account associated with the user. The balance of the front money is drawn down from the front money account (in certain instances via the issuance of markers) and accessible by the front money handling system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal).

In certain embodiments, the gaming establishment fund management system utilizes one mobile device application to interact with the different components of (or in communication with) the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the gaming establishment fund management system utilizes multiple mobile device applications to interact with the different components of (or in communication with) the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the gaming establishment fund management system enables a user to pair or link their mobile device to a gaming establishment device, such as a gaming device (e.g., an EGM) or a non-gaming device (e.g., a point-of-sale terminal). In these embodiments, the pairing or linkage between the mobile device and the gaming establishment device occurs via one or more applications being run or executed on the mobile device. In certain such embodiments, the mobile device application prompts the user to cause the mobile device to engage the gaming establishment device or a component of a gaming establishment management system supported by an EGM (e.g., a slot machine interface board (“SMIB”)). After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming establishment device (or a component of the gaming establishment device and/or the mobile device application) proceeds with operating with a component of (or in communication with) the gaming establishment fund management system to log the user into an account maintained by that component (if necessary) and request authorization of the requested action.

It should be appreciated that in different embodiments, in addition to or alternatively from utilizing a mobile device running a mobile device application to facilitate the completion of one or more actions, the gaming establishment fund management system utilizes a kiosk, a gaming device (e.g., an interface of an EGM or gaming table component), a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to facilitate the completion of one or more actions. It should be further appreciated that while illustrated in FIG. 1 as using a mobile device running a mobile device application to enable a user access to the system, as mentioned above, a physical instrument, such as a smart card or a user issued magnetic striped card may additionally or alternatively be utilized to enable a user such access. It should also be appreciated that two or more of the systems, sub-systems and components of the present disclosure may be combined into a single system, sub-system or component. For example, while an external funding system and the gaming establishment fund management system are illustrated as separate components, the external funding system and the gaming establishment fund management system may be combined into a single component operable to accomplish the various tasks each of such separate components are described as accomplishing individually.

In certain embodiments, the system employs a service that enforces rules and/or limitations including, but are not limited to, jurisdictional controls, self-imposed limits, state governmental controls and federal governmental controls. In these embodiments, the system provides the logic to determine how to transfer funds between gaming establishment accounts (and/or between a gaming establishment account and an external account), and how much funds to transfer between gaming establishment accounts (and/or between a gaming establishment account and an external account) to satisfy a request for funds while staying within the confines of such rules. In certain embodiments, the system additionally or alternatively employs a service that tracks and merges transaction history of the interconnected components of the system such that all transactions within the system have a “master” transaction record that ties all of the various fund transfers to a single initiating funds transfer.

In certain embodiments, the system enables a transfer of funds between different accounts maintained by one or more gaming establishment components (and/or between an account maintained by a gaming establishment component and an external account). In these embodiments, the system employs a fund coalescing service for interfacing with the various components to facilitate balance inquiries and the transfer of funds to a dynamically determined destination account. In certain embodiments, upon an occurrence of a fund coalescence event in association with a destination account, the service collects data from various components and utilizes such collected data to cause a transfer of funds to the destination account. Such a preemptive transfer enables the system to provide a singular view of the balance of funds available without having to repeatedly consume processing resources to query different accounts for balance information to provide such a singular view. That is, since a plurality of different gaming establishment accounts are maintained for a user in association with one or more gaming establishment sites, since the funds in such accounts are accessible by the user in response to one or more actions and since funds residing in such accounts represent an increased demand on the network when these accounts are not transacted against (due to a transaction multiplier effected required by the system initiating a balance or transfer transaction having to reach out to each account for balance inquiry or a funds transfer from a different account), the system operates to determine, based on one or more factors, a destination account and then cause a transfer funds from one or more non-destination accounts to the determined destination account. Put differently, while funds residing in a first gaming establishment account provide direct access to such funds when the first gaming establishment account is transacted against (and further provide resiliency of access to the funds in case of a network outage or other malfunction associated with other gaming establishment accounts), when the first gaming establishment account is not transacted against, funds residing in the first gaming establishment account increase the level of stress on the system by increasing the amount of fund data communicated between system components which in turn reduces the operating speed of the system. To combat such system slowdowns, in certain embodiments, the system periodically determines which of the plurality of gaming establishment accounts of which of the plurality of gaming establishment sites is (or is likely) to be transacted against and combines the funds held in one or more other gaming establishment accounts to the determined gaming establishment account.

In certain embodiments, upon an occurrence of a fund coalescence event, the system operates to determine a destination gaming establishment account (or access a previously determined gaming establishment account) and facilitates zero, one or more transfers of funds associated with zero, one or more non-destination gaming establishment accounts (and/or an external account) to the destination gaming establishment account. As described above, such a consolidation of funds to a dynamically determined destination gaming establishment account reduces subsequent system stresses by reducing (or eliminating) the need for certain gaming establishment computing components to interface with each other to, amongst other purposes, request fund data from the gaming establishment accounts such gaming establishment computing components maintain.

In certain embodiments, a fund coalescence event occurs in association with a gaming establishment account. In these embodiments, when one or more events occur (or are anticipated to occur) in association with a gaming establishment account, the system causes a fund coalescence event to occur in association with that gaming establishment account. In certain embodiments, when a fund coalescence event occurs in association with a gaming establishment account, the system operates to transfer funds to that gaming establishment. In these embodiments, an occurrence of a fund coalescence event associated with a gaming establishment account results in that gaming establishment account being a destination to which funds from other gaming establishment accounts and/or from an external account are transferred to.

In certain embodiments, a fund coalescence event occurs based on a balance inquiry of funds associated with a plurality of gaming establishment accounts. In these embodiments, the balance inquiry in association with the plurality of gaming establishment accounts results in the system causing a transfer of funds from one or more of the plurality of gaming establishment accounts to a single one of the plurality of gaming establishment accounts. For example, in association with an inquiry into an aggregate balance of funds of the gaming establishment accounts associated with a user for a plurality of gaming establishment sites (i.e., an occurrence of a fund coalescence event), the system operates to transfer funds from such gaming establishment accounts to a destination gaming establishment account. In certain embodiments, a fund coalescence event occurs based on a balance inquiry of funds associated with a gaming establishment account. In these embodiments, the balance inquiry in association with one gaming establishment account results in the system causing a transfer of funds from other gaming establishment accounts and/or from an external account to that gaming establishment account. For example, in association with an inquiry into a balance of funds associated with a first gaming establishment account (i.e., an occurrence of a fund coalescence event in association with the first gaming establishment account), the system operates to transfer funds from a second gaming establishment account to the first gaming establishment account.

In certain embodiments, a fund coalescence event occurs based on a transfer (or an attempted transfer) of funds to a gaming establishment account from another gaming establishment account. In these embodiments, the transfer (or attempted transfer) of funds to that gaming establishment account from another gaming establishment account results in the system causing a transfer of funds from one or more other gaming establishment accounts to that gaming establishment account. For example, in association with a transfer of funds from a first gaming establishment account to a second gaming establishment account (i.e., an occurrence of a fund coalescence event in association with the second gaming establishment account), the system operates to additionally transfer funds from a third gaming establishment account to the second gaming establishment account.

In certain embodiments, a fund coalescence event occurs based on a deposit of funds into a gaming establishment account. In these embodiments, the deposit of funds into a gaming establishment account results in the system causing a transfer of funds from one or more other gaming establishment accounts to that gaming establishment account. For example, in association with a deposit of funds into a first gaming establishment account (i.e., an occurrence of a fund coalescence event in association with the first gaming establishment account), the system operates to additionally transfer funds from a second gaming establishment account to the first gaming establishment account.

In certain embodiments, a fund coalescence event occurs based on a transfer (or an attempted transfer) of funds to a gaming establishment account from an external account. In these embodiments, the transfer (or attempted transfer) of funds to a gaming establishment account from an external account results in the system causing a transfer of funds from one or more other gaming establishment accounts to that gaming establishment account. For example, in association with a transfer of funds from an external account to a first gaming establishment account (i.e., an occurrence of a fund coalescence event in association with the first gaming establishment account), the system operates to additionally transfer funds from a second gaming establishment account to the first gaming establishment account.

In certain embodiments, the occurrence of a fund coalescence event associated with a gaming establishment account results in the system determining that that gaming establishment account qualifies as a destination gaming establishment account which funds are transferred to. In certain other embodiments, when a fund coalescence event occurs in association with a gaming establishment account, the system operates to transfer funds from that gaming establishment account. In these embodiments, an occurrence of a fund coalescence event associated with a gaming establishment account results in that gaming establishment account not being a destination to which funds from other gaming establishment accounts are transferred to. Rather, such an occurrence results in that gaming establishment account transferring funds to a separately determined destination gaming establishment account.

In certain embodiments, a fund coalescence event occurs in association with a gaming establishment account based on one or more factors or attributes associated with that gaming establishment account. In these embodiments, the system employs such factors or attributes to determine whether a fund coalescence event occurs in association with that gaming establishment account and if so, whether that gaming establishment qualifies as a destination account (for funds from other gaming establishment accounts and/or from an external account) or a source account (from which funds are transferred to another gaming establishment account).

In certain embodiments in which a fund coalescence event occurs based on one or more factors or attributes associated with a gaming establishment account, a fund coalescence event occurs in association with a gaming establishment account when that gaming establishment account has remained idle for a designated period of time. That is, for zero, one or more gaming establishment accounts, the system determines whether that gaming establishment account is being actively transacted against or was actively transacted against within a designated period of time. In these embodiments, a gaming establishment account is transacted against if that gaming establishment account has been involved in any transaction (e.g., fund transfer) or attempted transaction (e.g., attempted fund transfer). For example, a gaming establishment account is considered transacted against if any one or more of: (i) any amount of funds has been transferred to that gaming establishment account from another account within a designated period of time, (ii) any amount of funds has been deposited in that gaming establishment account within the designated period of time, (iii) any amount of funds has been transferred out of that gaming establishment account (and to another account) within the designated period of time, and/or (iv) any amount of funds has been withdrawn from that gaming establishment account within the designated period of time.

In certain embodiments in which a fund coalescence event occurs based on one or more factors or attributes associated with a gaming establishment account, a fund coalescence event occurs in association with a gaming establishment account when a balance of that gaming establishment account exceeds a threshold maximum amount of funds. That is, for zero, one or more gaming establishment accounts, the system determines whether that gaming establishment account currently includes an amount of funds that is greater than a designated or threshold maximum amount of funds associated with that account. In certain embodiments in which a fund coalescence event occurs based on one or more factors or attributes associated with a gaming establishment account, a fund coalescence event occurs in association with a gaming establishment account when a balance of that gaming establishment account is greater than zero, but less than a threshold minimum amount of funds. That is, for zero, one or more gaming establishment accounts, the system determines whether that gaming establishment account currently includes an amount of funds that is less than a designated or threshold minimum amount of funds associated with that account. In certain embodiments, different accounts are associated with the same threshold amount of funds. In certain embodiments, different accounts are associated with different threshold amounts of funds. In such embodiments, any suitable factor, such as type of account, historical account balances and historical account activity, may determine the threshold amount of funds for such accounts.

In certain embodiments, a fund coalescence event occurs independent of any gaming establishment account. In these embodiments, upon an occurrence of a fund coalescence account, the system determines a destination account to which funds from other gaming establishment accounts and/or from an external account are to be transferred to.

In certain embodiments, a fund coalescence event occurs based on an event occurring at a gaming establishment device, such as a gaming device (e.g., an EGM) or a non-gaming device (e.g., a point-of-sale terminal). In certain such embodiments, a fund coalescence event occurs when a user logs into an EGM, such as by presenting their player tracking card to the EGM to log into a player tracking system.

In certain embodiments, a fund coalescence event occurs independent of any event occurring at a gaming establishment device. In certain such embodiments, a fund coalescence event occurs when the system performs a balance check of funds held in one or more gaming establishment accounts. In certain embodiments, a fund coalescence event occurs at a set interval of user inactivity, such as after a set amount of time since a user last engaged with a gaming establishment device. In certain other embodiments, a fund coalescence event occurs at a set interval of user activity, such as after a set amount of time since a user initially engaged with a gaming establishment device. In these embodiments, the system determines, at designated intervals, whether a fund coalescence event occurs in association with one or more gaming establishment accounts. For example, the system employs a suitable sampling rate, such as a sampling rate based on time elapsed, transactions occurring in association with one or more gaming establishment accounts or one or more other factors, wherein at each sampling rate interval, the system determines whether a fund coalescence event occurs in association with such gaming establishment accounts.

Upon an occurrence of a fund coalescence event not associated with a gaming establishment account, the system determines a gaming establishment account to operate as a destination for funds from other gaming establishment accounts and/or from an external account. That is, since funds reside in multiple different gaming establishment accounts associated with one or more gaming establishment sites, when a fund coalescence event occurs, the system determines which of these multiple different gaming establishment accounts should be a destination for such funds.

In certain embodiments in which a fund coalescence event occurs based on an event occurring at a gaming establishment device, the system employs a location of that gaming establishment device to determine a gaming establishment account to operate as a destination for funds from other gaming establishment accounts and/or from an external account. For example, when a fund coalescence event occurs based on a user logging into an EGM, the system determines the destination gaming establishment account as the gaming establishment account associated with the gaming establishment site where the EGM is located. In another example, when a fund coalescence event occurs based on a user at a gaming establishment device requesting to view an aggregate balance of funds held in multiple gaming establishment accounts, the system determines the destination gaming establishment account as the gaming establishment account associated with the gaming establishment site where the gaming establishment device is located.

In certain embodiments, upon an occurrence of a fund coalescence event not associated with a gaming establishment account, the system additionally or alternatively employs prior gaming establishment account activity to determine a gaming establishment account to operate as a destination for funds. In these embodiments, the system determines which gaming establishment account a user last transacted against (or last transacted against within a designated period of time) and designates that gaming establishment account as a destination to route funds to from one or more other gaming establishment accounts (and/or from an external account).

In certain embodiments, upon an occurrence of a fund coalescence event not associated with a gaming establishment account, the system additionally or alternatively employs prior fund transfer activity to determine a gaming establishment account to operate as a destination for funds. In these embodiments, the system determines which gaming establishment account a user last transferred funds to (or last transferred funds to within a designated period of time) and designates that gaming establishment account as a destination to route funds to from one or more other gaming establishment accounts (and/or from an external account).

In certain embodiments, upon an occurrence of a fund coalescence event not associated with a gaming establishment account, the system additionally or alternatively employs prior gaming establishment activity to determine a gaming establishment account to operate as a destination for funds. In these embodiments, the system determines which gaming establishment activity a user engaged in (or last engaged in within a designated period of time) and designates a gaming establishment account associated with that gaming establishment activity as a destination to route funds to from one or more other gaming establishment accounts (and/or from an external account). For example, when a fund coalescence event occurs based on a user logging into an EGM, the system determines that the user last engaged in sporting event wagering activity. In this example, employing the user's historical behavior (e.g., the user is a sports bettor as opposed to a game of chance bettor), the system designates a sporting event wagering account associated with the user as the destination gaming establishment account to route funds to from one or more other gaming establishment accounts (and/or from an external account). In another example, when a fund coalescence event occurs based on a user remote from any gaming establishment device accessing an online casino associated with a gaming establishment, the system determines that the user last engaged in online wagering activity. In this example, employing the user's historical behavior (e.g., the user prefers betting on online games of chance and not online sports betting), the system designates an online wagering account associated with the user as the destination gaming establishment account to route funds to from one or more other accounts associated with the gaming establishment (and/or from an external account).

In certain embodiments, upon an occurrence of a fund coalescence event not associated with a gaming establishment account, the system additionally or alternatively employs a user designation to determine a gaming establishment account to operate as a destination for funds. In these embodiments, the system determines which gaming establishment account a user selects to transfer funds to (or otherwise classifies as a default gaming establishment account) and designates that gaming establishment account as a destination to route funds to from one or more other gaming establishment accounts (and/or from an external account).

In certain embodiments, upon an occurrence of a fund coalescence event not associated with a gaming establishment account, the system additionally or alternatively employs anticipated user activity to determine a gaming establishment account to operate as a destination for funds. In these embodiments, the system determines which gaming establishment account a user is anticipated to transact against and designates that gaming establishment account as a destination to route funds to from one or more other gaming establishment accounts (and/or from an external account). For example, upon data communicated to and/or from a gaming establishment hotel system that a user is expected to check into a hotel associated with a first gaming establishment, the system determines a destination gaming establishment account as the gaming establishment account associated with that first gaming establishment. In this example, prior to the user checking into the hotel, the system consolidates funds held in other gaming establishment accounts to the destination gaming establishment account and/or transfers funds from one or more external accounts to the designation gaming establishment account.

In certain embodiments, upon an occurrence of a fund coalescence event not associated with a gaming establishment account, the system additionally or alternatively employs anticipated gaming establishment activity to determine a gaming establishment account to operate as a destination for funds. In these embodiments, the system determines which gaming establishment activity a user is anticipated to engage in and designates a gaming establishment account associated with that anticipated gaming establishment activity as a destination to route funds to from one or more other gaming establishment accounts (and/or from an external account). For example, when a fund coalescence event occurs based on a determination that a user is scheduled to arrive at a gaming establishment at a certain point in time, the system determines that the user is anticipated to engage in game of chance wagering activity at one or more EGMs of the gaming establishment. In this example, employing the user's anticipated behavior, the system designates a cashless wagering account associated with the user as the destination gaming establishment account to route funds to from one or more other gaming establishment accounts (and/or from an external account).

In certain embodiments, upon an occurrence of a fund coalescence event not associated with a gaming establishment account, the system additionally or alternatively employs anticipated gaming establishment account activity to determine a gaming establishment account to operate as a destination for funds. In these embodiments, the system determines which gaming establishment account a user is anticipated to transact against and designates that gaming establishment account as a destination to route funds to from one or more other gaming establishment accounts (and/or from an external account).

It should be appreciated that in certain embodiments, the system employs multiple factors in determining which gaming establishment account to designate as a destination account to route funds to from one or more other gaming establishment accounts (and/or from an external account). In certain such embodiments the system accounts for zero, one or more activities (e.g., prior fund transfer activity, anticipated fund transfer activity, prior gaming establishment activity, anticipated gaming establishment activity, prior user activity, anticipated user activity), zero, one or more events (e.g., logging into a gaming establishment device, a balance inquiry, a transfer of funds, a deposit of funds) and the architecture of a determined destination gaming establishment account (i.e., is that gaming establishment account associated with a single gaming establishment site or associated with multiple gaming establishment sites), in the intelligent routing of funds. For example, upon the system determining that the user has logged into an EGM at a first gaming establishment and begun placing sporting event wagers (or the system determines that the user prefers a sports betting vertical over other gaming establishment verticals), the system determines that a sporting event wagering account maintained for the user in association with the first gaming establishment qualifies as a destination gaming establishment account. In this example, the system then automatically routes funds to that destination gaming establishment account from one or more other gaming establishment accounts (and/or from an external account). Continuing with this example, if the user subsequently moves to a second gaming establishment to place sporting event wagers and if the sporting event wagering account is also associated with the second gaming establishment (i.e., the system that supports the sporting event wagering account is multi-site), the funds are already in the appropriate destination gaming establishment account for use. As illustrated by this example, in coalescing funds to the optimal destination, the system takes into account the gaming vertical (e.g., a multi-site vertical or a single site vertical), the supporting wallet architecture of that gaming vertical and zero, one or more user gaming vertical preferences.

In certain embodiments, to consolidate funds from one or more non-destination gaming establishment accounts to a destination gaming establishment account, the system queries one or more (or each) of the non-destination gaming establishment accounts to determine a fund balance of such non-destination gaming establishment accounts. The system then causes an automatic transfer of an amount of funds from one or more of such non-destination gaming establishment accounts (that have a positive fund balance) to the destination gaming establishment account. In certain embodiments, the system automatically transfers the entire amount of funds from one or more non-destination gaming establishment accounts to the determined destination gaming establishment account. In certain embodiments, the system automatically transfers less than the entire amount of funds from one or more non-destination gaming establishment accounts to the determined destination gaming establishment account. In one such embodiment in which a fund coalescence event occurs in association with a balance of a non-destination gaming establishment exceeding a threshold maximum amount of funds, the system automatically transfers the amount which the non-destination gaming establishment account exceeds the threshold (or an amount which the non-destination gaming establishment account exceeds the threshold plus a designated amount).

Following the determination to automatically transfer an amount of funds from one or more non-destination gaming establishment accounts to a determined destination gaming establishment account, each respective component which maintains such non-destination gaming establishment accounts update the respective non-destination gaming establishment account to reflect a reduction of the determined amount of funds and communicates an authorization to the component which maintains the destination gaming establishment account. The component that maintains the destination gaming establishment account then increases a balance of available funds of the destination gaming establishment account by the transferred amount(s) of funds. In these embodiments, automatically consolidating part or all of the funds across multiple gaming establishment accounts to a dynamically determined singular destination gaming establishment account enables the system to present a single view of the funds available (or a majority of the funds available) via a balance of the currently designated destination gaming establishment account as well as reduces the number of account balance queries associated with the system since most, if not all, funds will reside, by design, in the singular destination gaming establishment account.

Accordingly, in certain embodiments and responsive to a first occurrence of a fund coalescence event at a first point in time, the system determines a first gaming establishment account from a plurality of gaming establishment accounts (which are associated with a user and further associated with a plurality of gaming establishment sites), and, for each of the plurality of gaming establishment accounts other than the first gaming establishment account, causes a transfer of any funds associated with that gaming establishment account to the determined first gaming establishment account. In these embodiments, responsive to a second occurrence of the fund coalescence event at a second, subsequent point in time, the system determines a second, different gaming establishment account from the plurality of gaming establishment accounts, and for each of the plurality of gaming establishment accounts other than the second, different gaming establishment account, causes a transfer of any funds associated with that gaming establishment account to the determined second, different gaming establishment account.

It should be appreciated that since, in certain instances, a user is associated with multiple gaming establishment accounts affiliated with multiple gaming establishments, as the user accesses these different gaming establishment accounts over different periods of time, the destination gaming establishment account varies over such different periods of time. That is, rather than simply consolidating funds to a static destination gaming establishment account to ease balance inquiries on the system, the system dynamically employs, at different points in time, different destination gaming establishment accounts which funds are individually consolidated in to, amongst other benefits, ease balance inquiries on the system. For example, if a user at a gaming establishment device of a first gaming establishment at which the user is associated with a first gaming establishment account requests to view a balance of funds held across multiple gaming establishment accounts, and if the system determines that the last fund coalescence event occurred in association with a second, different gaming establishment account associated with a second, different gaming establishment (and/or determines that the last fund coalescence event occurred more than a predefined amount of time ago), the system determines that the second gaming establishment account no longer qualifies as a destination gaming establishment account. In this example, in association with an occurrence of a fund coalescent event, the system determines that the first gaming establishment now qualifies as the destination gaming establishment account and causes a transfer of funds from other gaming establishment accounts and/or from an external account to the first gaming establishment account. As illustrated by this example, the system employs multiple destination gaming establishment accounts (which funds are consolidated into) over different periods of time to account for the movement of users across different gaming environments while still reducing operational stresses otherwise associated with interfacing with these different gaming environments to determine an amount of funds held in these different gaming establishment accounts.

Accordingly, in certain embodiments, responsive to a receipt of data associated with a transfer of funds from an external account following an occurrence of a fund coalescence event within a predefined period of time, the system modifies, based on the data associated with the transfer of funds from the external account, a balance of a first gaming establishment account associated with the occurrence of the fund coalescence event. The first gaming establishment account is one of a plurality of gaming establishment accounts associated with a user, and the plurality of gaming establishment accounts are associated with a plurality of gaming establishment sites. In these embodiments, responsive to the receipt of data associated with the transfer of funds from the external account following the occurrence of the fund coalescence event outside of the predefined period of time, the system determines a second gaming establishment account from the plurality of gaming establishment accounts, and modifies, based on the data associated with the transfer of funds from the external account, a balance of the determined second gaming establishment account.

In certain other embodiments, responsive to a receipt of data associated with a first transfer of funds from an external account, the system determines, independent of any input from a user in association with the first transfer of funds, a first gaming establishment account from a plurality of gaming establishment accounts (which are associated with the user and associated with a plurality of gaming establishment sites), and modifies, based on the first transfer of funds from the external account, a balance of the determined first gaming establishment account. In these embodiments, responsive to a receipt of data associated with a second, subsequent transfer of funds from the external account, the system determines, independent of any input from the user in association with the second, subsequent transfer of funds, a second, different gaming establishment account from the plurality of gaming establishment accounts, and modifies, based on the second, subsequent transfer of funds from the external account, a balance of the determined second, different gaming establishment account.

It should be further appreciated that since, in certain instances, a user is associated with multiple gaming establishment accounts affiliated with one or more gaming establishments and different gaming establishment verticals (e.g., wagering at a gaming establishment device, wagering associated with a gaming establishment but occurring remote from a gaming establishment device, and gaming establishment retail transactions) of these one or more gaming establishments, as the user accesses these different gaming establishment accounts over different periods of time, the destination gaming establishment account varies over such different periods of time. In other words, the system of certain embodiments of the present disclosure dynamically employs, at different points in time and based on different user historical behavior (e.g., which gaming establishment verticals a user previously engaged in) and/or different anticipated user behavior (e.g., which gaming establishment verticals is a user anticipated to engage in), different gaming establishment accounts which funds are individually consolidated in to ease balance inquiries on the system and/or the need to interface with multiple components for certain transactions to occur. As such, the system employs multiple destination gaming establishment accounts (which funds are consolidated into) over different periods of time to account for different user behavior (e.g., different gaming establishment verticals accessed) while still reducing operational stresses otherwise associated with interfacing with components that maintain these different gaming establishment accounts in determining any amounts of funds held in these different gaming establishment accounts.

Accordingly, in certain embodiments, responsive to a first gaming establishment activity associated with a user occurring (or anticipated to occur) at a first point in time, the system determines, based on the first gaming establishment activity, a first gaming establishment account from a plurality of gaming establishment accounts associated with the user, and causes a transfer of funds associated with at least one of the plurality of gaming establishment accounts other than the first gaming establishment account to the determined first gaming establishment account. In these embodiments, responsive to a second gaming establishment activity associated with the user occurring (or anticipated to occur) at a second, subsequent point in time, the system determines whether a second gaming establishment account associated with the second gaming establishment activity is different from the first gaming establishment account, and responsive to the determination being that the second gaming establishment account is different from the first gaming establishment account, causes a transfer of funds associated with at least one of the plurality of gaming establishment accounts to the second gaming establishment account.

It should be appreciated that the consolidation of funds from multiple gaming establishment accounts associated with multiple gaming establishments to a destination gaming establishment offers certain benefits in instances in which a gaming establishment operator runs one or more gaming establishments in different gaming jurisdictions. In such instances, one of the problems or challenges with a cross-jurisdictional gaming establishment operator is isolating operations across those various gaming establishment sites. For example, a gaming establishment operator might have one gaming establishment in State A, and another gaming establishment in State B. In this example, each respective state may require the gaming establishment operator to hold backing funds for a user's associated cashless wagering account in a bank account located in a bank within each respective state. Holding these funds in a backing bank account is associated with cashless wagering account solvency in that the funds (or IOUs) represented by the user's associated cashless wagering account is actually backed up by a deposit in a backing bank account that holds actual money. In these instances, when users move funds between gaming establishment accounts associated with different gaming establishments in different states, the funds backing a user's associated cashless wagering account also have to be transferred across the jurisdictions. However, this transfer requires fund transfers between the two banks leveraged by the gaming establishment operator for holding backing funds (one for each jurisdiction). Furthermore, such transfers of funds across state lines require settlement of that transfer between the respective banks which often takes time, such as two business days to settle. Accordingly, in view of these timing constraints, the system of the present disclosure enables funds to be transferred from an external account to a determined destination gaming establishment associated with a specific backing bank account to save time on transfers between backing bank accounts. Such targeted transfers reduce the time it takes for the transferred funds to be available for use within a gaming establishment environment.

In certain embodiments, once the system performs a funds coalescence and consolidates funds from one or more non-destination gaming establishment accounts to the destination account, the system records, in a database, a state, such as a funds coalescence state (“FCS”) in association with the transaction. Information associated with the recorded state includes at least the time of the coalescence and the gaming establishment site of the coalescence. The recorded information is available and accessible, such as via a data store, by the computing components that maintain gaming establishment accounts at the gaming establishment sites. Such a configuration provides that when the user subsequently requests a transaction in association with a gaming establishment account of a gaming establishment site, the system queries the database that maintains FCS data to determine if the user's funds have been recently coalesced at the gaming establishment site associated with that transaction. If the funds have been recently coalesced, the system intelligently determines that no other computing components of any other gaming establishment sites need to be queried for additional information.

In operation of certain embodiments employing FCS data to minimize system stresses, when a user requests an aggregate balance of funds held across multiple gaming establishment accounts associated with multiple gaming establishment sites, the system queries the database that maintains FCS data to determine if the user's funds have recently been coalesced to a gaming establishment account of the gaming establishment site where the balance request originated. In these embodiments, if the funds have been recently coalesced, the system intelligently determines that no other computing components of any other gaming establishment sites need to be queried for the balance information.

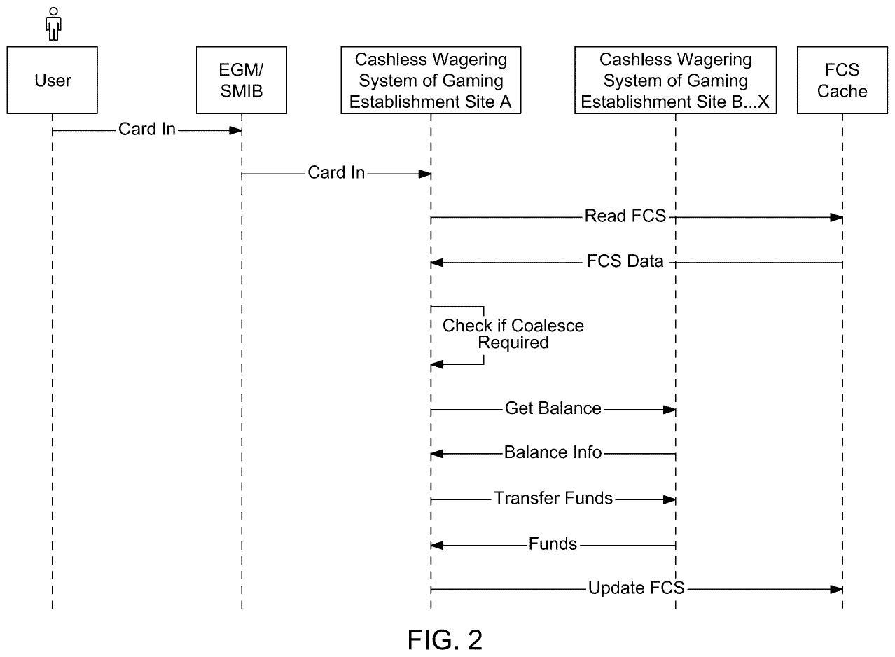

In operation of certain other embodiments employing FCS data to minimize system stresses, when a user requests to transfer funds to a gaming establishment device, the system queries the database that maintains the FCS data to determine if the user's funds have recently been coalesced to a gaming establishment account of the gaming establishment site where the gaming establishment device is located. In these embodiments, if the funds have been recently coalesced, the system intelligently determines that no other computing components of any other gaming establishment sites need to be transacted against to transfer funds from (to then be transferred to the gaming establishment device). For example, as seen in FIG. 2, following a user at an EGM at gaming establishment site A logging into the EGM, the cashless wagering system of gaming establishment site A interfaces with an FCS cache to determine if a fund coalescence event most recently occurred in association with gaming establishment site A. If a fund coalescence event most recently occurred in association with gaming establishment site A and that occurrence is still valid (e.g., has not lapsed), the system determines that funds from other cashless wagering accounts maintained for the user by other cashless wagering systems have already been consolidated to the cashless wagering system of gaming establishment site A (and these other cashless wagering systems do not need to be queried for any balance information or otherwise transacted against). On the other hand, if a fund coalescence event did not most recently occur in association with gaming establishment site A (or did but that occurrence is no longer valid (e.g., has lapsed), the system operates with cashless wagering systems of other gaming establishment sites to obtain fund balances in the cashless wagering accounts maintained for the user by these other cashless wagering systems. The system then causes zero, one or more transfers of any fund balances in such other cashless wagering accounts to the cashless wagering account maintained for the user by the cashless wagering system of gaming establishment site A. As seen in FIG. 2, following such a consolidation of funds from other cashless wagering accounts to the cashless wagering account maintained for the user by the cashless wagering system of gaming establishment site A, the system records a FCS in association with the transaction such that future transactions occurring in association with the cashless wagering system of gaming establishment site A may occur without the need to communicate balance data and/or fund transfer data between different computing components of different gaming establishment accounts.

As illustrated in this example, by recording certain data associated with a funds coalescence, the system operates to reduce certain transactions and thus saves processing resources from being used to perform such transactions. That is, if the system determines that funds from multiple gaming establishment accounts have recently been coalesced to a destination gaming establishment account, the system determines that no other computing components that maintain any other gaming establishment accounts generally need to be queried for a period of time (subject to no other destination gaming establishment account being determined). In other words, once the system is aware that funds have already been transferred to a specific gaming establishment account enables the system to save processing resources and speed up system operations by bypassing any balance information queries of other gaming establishment accounts.

In certain embodiments, since different gaming establishment accounts qualify as a destination gaming establishment account at different points in time (e.g., a user moving from a first gaming establishment to a second gaming establishment may cause the destination gaming establishment account to change from a first gaming establishment account associated with the first gaming establishment to a second gaming establishment account associated with the second gaming establishment), the recordation of an FCS may periodically need to be updated. In these embodiments, the system employs the maintained FCS data to determine whether or not any query is needed. In certain such embodiments, if a user requests a transaction (e.g., a balance inquiry and/or a funds transfer request), and the gaming establishment site recorded in the FCS database for that user is not the gaming establishment site where the request was made, the system causes a fund coalescence event to occur, performs the fund coalescence as described above and updates the FCS database upon completion. In certain other embodiments, if a user requests a transaction (e.g., a balance inquiry and/or a funds transfer request), and the duration since the last occurrence of a fund coalescence is greater than a predefined amount of time (e.g., it has been more than an hour since funds were consolidated to a dynamically determined destination account), the system causes a fund coalescence event to occur, performs the fund coalescence as described above and updates the FCS database upon completion.

In certain embodiments, as described above, a fund coalescence event occurs based on one or more events, such as a user requested transaction, in which following the occurrence of the event, the system employs any recorded FCS information to direct funds to a specific gaming establishment account. In certain embodiments, a fund coalescence event automatically occurs independent of the above-described events. In these embodiments, following the automatic occurrence of the fund coalescence event, the system employs any recorded FCS information to direct funds to a specific gaming establishment account. In certain such embodiments, the system periodically determines a list of recently active users and automatically determines whether to cause any fund coalescence events to occur in association with such active users. In these embodiments, for each active user in which the system automatically causes a fund coalescence event to occur, the system employs any recorded FCS information to direct funds to a specific gaming establishment account for that user. In these embodiments, in anticipation of certain requests being made of the system, the system proactively causes one or more fund coalescence events to occur and consolidates funds into a specific account for a user to minimize the operational stress placed on the system when such requests are ultimately made of the system.

In certain embodiments, the system selectively applies the employment of fund coalescence events. In these embodiments, the system weighs the computational resources saved from such fund coalescence events relative to the computational resources used to determine a destination gaming establishment account and consolidate funds to the destination gaming establishment account. That is, the system of certain embodiments is configured to selectively employ the coalescence functionality. For example, in instances in which there are relatively few gaming establishment sites (e.g., two gaming establishment sites), the system determines (or may be manually configured) not to employ fund coalescence events as the overall load reduction accomplished is minimal. On the other hand, in instances in which there are relatively more gaming establishment sites (e.g., three or more gaming establishment sites), the system determines (or may be manually configured) to employ fund coalescence events as the overall load reduction accomplished is warranted.

Such a configuration of consolidating funds from one or more gaming establishment accounts to a dynamically determined gaming establishment account limits the quantity of gaming establishment accounts which need to be accessed for subsequent balance inquiries and/or requested fund transfers and thus alleviates the quantity of transactions the system needs to perform to accomplish such balance inquiries and/or such requested fund transfers. Put differently, utilizing different dynamically determined gaming establishment accounts as temporary repositories of funds results in less system transactions needing to occur between different components to accomplish a user's objective to view a aggregate balance and/or transact against funds otherwise held across multiple gaming establishment accounts (thus increasing system efficiency by reducing the need to request balance information against multiple gaming establishment accounts and/or execute multiple transactions against multiple gaming establishment accounts to obtain the same funding).

In various embodiments, prior to consolidating funds to a dynamically determined destination gaming establishment account upon an occurrence of a fund coalescence event, the system enables one or more of the different gaming establishment accounts maintained to be funded from one or more sources. In certain embodiments, the system enables such gaming establishment accounts to be directly funded from one or more of such sources. In certain embodiments, the system enables such gaming establishment accounts to be indirectly funded from one or more of such sources, such as by an amount of funds from such sources first being transferred to another gaming establishment account and then such an amount of funds being transferred from the other gaming establishment account to the gaming establishment account.

In certain embodiments, each of one or more gaming establishment accounts is associated with one or more external accounts, such as one or more credit card accounts, one or more debit card accounts and/or one or more third-party maintained accounts (e.g., one or more PayPal® accounts or Venmo® accounts). In certain embodiments, the user establishes a gaming establishment account by a deposit of funds (such as at a kiosk) to be subsequently utilized in association with the mobile device application. In other embodiments, each of one or more of the gaming establishment accounts is funded via a mobile device electronic fund transfer, such using Apple Pay™ or Android Pay™. It should be appreciated that in different embodiments, the system utilizes a mobile device running a mobile device application, a kiosk, an EGM, a gaming table component, a service window displayed by a gaming device (e.g., a remote host controlled service window displayed by an EGM) and/or a gaming establishment interface to facilitate the transfer of funds from a third-party account. In certain embodiments, the system enables funds to be deposited in a gaming establishment account via activating a line of credit associated with the user.

In certain embodiments, the system enables funds to be deposited in a gaming establishment account via a gaming device, such as an EGM. In certain embodiments, the system enables a user that has an amount of cash to utilize a gaming device to convert the cash to an amount deposited into a gaming establishment account (which may be subsequently transferred utilizing a mobile device application). In other embodiments, the system enables funds to be deposited in a gaming establishment account via a gaming device that accepts printed ticket vouchers. In these embodiments, the system enables a user that has one or more printed ticket vouchers to utilize a gaming device to convert the printed ticket voucher to an amount deposited into a gaming establishment account (which may be subsequently transferred utilizing a mobile device application).

In certain embodiments, the system enables funds to be deposited in a gaming establishment account via a gaming establishment interface, such as a gaming establishment cage or desk. In certain embodiments, the system enables a user that has an amount of cash to utilize a gaming establishment interface, such as a gaming establishment cage or desk to convert the cash to an amount deposited into a gaming establishment account (which may be subsequently transferred utilizing a mobile device application). In other embodiments, the system enables funds to be deposited in a gaming establishment account via a gaming establishment interface that accepts printed ticket vouchers. In these embodiments, the system enables a user that has one or more printed ticket vouchers to utilize a gaming establishment interface to convert the printed ticket voucher to an amount deposited into a gaming establishment account (which may be subsequently transferred utilizing a mobile device application).

In certain embodiments, the system enables funds to be deposited in a gaming establishment account via a kiosk that accepts money. In certain embodiments, the system enables a user that has an amount of cash to utilize a kiosk to convert the cash to an amount deposited into a gaming establishment account (which may be subsequently transferred to a gaming device utilizing a mobile device application). In other embodiments, the system enables funds to be deposited in a gaming establishment account via a kiosk that accepts printed ticket vouchers. In certain embodiments, the system enables a user that has one or more printed ticket vouchers to utilize a kiosk to convert the printed ticket voucher to an amount deposited into a gaming establishment account (which may be subsequently transferred to a gaming device utilizing a mobile device application).

In certain embodiments, each of one or more of the gaming establishment accounts is associated with funds associated with one or more virtual ticket vouchers. In certain embodiments, the system enables a user associated with an amount of virtual ticket vouchers to utilize a gaming device (e.g., an EGM, a component of an EGM) a mobile device running a mobile device application, a kiosk and/or a gaming establishment interface to convert the virtual ticket vouchers to an amount deposited into a gaming establishment account.

In certain embodiments, the system enables a user to fund each of one or more of the gaming establishment accounts independent of the mobile device and independent of the mobile device application. In certain other embodiments, the system enables a user to utilize a mobile device running a mobile device application to fund each of one or more of the gaming establishment accounts. More specifically and utilizing the example of a kiosk, in one embodiment, to utilize a mobile device and a kiosk to facilitate the funding of a gaming establishment account, the user wirelessly pairs or otherwise connects a mobile device with a kiosk. In one example embodiment, the user moves the mobile device into the range of a wireless receiver of the kiosk. The kiosk and the launched or activated mobile device application of the mobile device negotiate a secure, authenticated connection with the proper functionality, versions and security settings. It should be appreciated that the kiosk wirelessly connects with the mobile device running the mobile device application in the same or similar fashion to how a mobile device is paired or connected with a gaming establishment device as described above. After connecting the mobile device to the kiosk, the kiosk prompts the user to deposit an amount of funds into the kiosk. In one such embodiment, the kiosk prompts the user to insert one or more bills into a bill acceptor of the kiosk. In another such embodiment, the kiosk additionally or alternatively prompts the user to deposit a physical ticket voucher (associated with an amount of funds) into the kiosk. In another such embodiment, the kiosk additionally or alternatively prompts the user to deposit a card associated with an external account, such as a credit card or debit card into the kiosk. In another such embodiment, the kiosk additionally or alternatively prompts the user to enter information associated with an external account, such as a credit card account, a PayPal® account, a Venmo® account, or a debit card account into the kiosk. In another such embodiment, the kiosk additionally or alternatively prompts the user to deposit an amount of funds into the kiosk using a mobile device electronic fund transfer, such using Apple Pay™ or Android Pay™.

In certain embodiments, upon receiving an amount of funds from the user and the user indicating to transfer the deposited amount of funds in association with the mobile device application, the kiosk communicates with one or more servers to transfer an amount of money to a gaming establishment account. In another such embodiment, upon receiving an amount of funds from the user and the user indicating to transfer the deposited amount of funds in association with an account or balance associated with the mobile device application, the kiosk communicates with one or more servers, such as a virtual ticket voucher server, to create a virtual ticket voucher associated with the amount of received currency. The system then transfers the created virtual ticket voucher to a gaming establishment account.

It should be appreciated that these electronic fund data transfers may occur in addition to or as an alternative from cash-based fund transfers and/or ticket voucher-based fund transfers. In one such embodiment, an amount of funds transferred to a gaming establishment device (e.g., an EGM or a retail point-of-sale terminal) is funded via any of an electronic fund transfer, a cash-based fund transfer or a ticket voucher-based fund transfer. In another embodiment, an amount of funds transferred from a gaming establishment device (e.g., an EGM or a gaming table component) is cashed out via any of an electronic fund transfer, a cash-based fund transfer or a ticket voucher-based fund transfer. In another embodiment, an amount of funds transferred to a gaming establishment device (e.g., an EGM or a retail point-of-sale terminal) is funded via an electronic fund transfer or a cash-based fund transfer (but is not funded via any ticket voucher-based fund transfer). In another embodiment, an amount of funds transferred from a gaming establishment device (e.g., an EGM or a gaming table component) is cashed out via an electronic fund transfer or a cash-based fund transfer (but is not cashed out via any ticket voucher-based fund transfer). In another embodiment, an amount of funds transferred to a gaming establishment device (e.g., an EGM or a retail point-of-sale terminal) is funded via an electronic fund transfer or a ticket voucher-based fund transfer (but is not funded via any cash-based fund transfer). In another embodiment, an amount of funds transferred from a gaming establishment device (e.g., an EGM or a gaming table component) is cashed out via an electronic fund transfer or a ticket voucher-based fund transfer (but is not cashed out via any cash-based fund transfer). In another embodiment, an amount of funds transferred to a gaming establishment device (e.g., an EGM or a retail point-of-sale terminal) is funded via an electronic fund transfer (but is not funded via a cash-based fund transfer nor a ticket voucher-based fund transfer). In another embodiment, an amount of funds transferred from a gaming establishment device (e.g., an EGM or a gaming table component) is cashed out via an electronic fund transfer (but is not cashed out via a cash-based fund transfer nor a ticket voucher-based fund transfer).

It should be appreciated that any functionality or process of the present disclosure may be implemented via one or more servers (associated with or independent of any component of any system of the present disclosure), one or more gaming establishment devices (e.g., a gaming device such as an EGM or a non-gaming device such as a point-of-sale terminal), one or more components of a gaming establishment device (such as a component of a gaming establishment management system supported by or otherwise located inside the gaming establishment device), or a mobile device application. For example, while certain data or information of the present disclosure is explained as being communicated from a gaming establishment device, or a component associated with a gaming establishment device to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers.

In certain embodiments, the above-described embodiments of the present disclosure may be implemented in accordance with or in conjunction with zero, one or more components of a gaming establishment fund management system (e.g., a cashless wagering system or a gaming establishment retail system); zero, one or more components of a gaming establishment patron management system; and/or zero, one or more gaming establishment devices. In these embodiments, such components each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the gaming establishment fund management system, the component of the gaming establishment patron management system, and/or the gaming establishment device; (3) accessing memory to configure or reconfigure parameters in the memory according to indicia read from the component of the gaming establishment fund management system, the component of the gaming establishment patron management system, and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the gaming establishment fund management system, the component of the gaming establishment patron management system, and/or the gaming establishment device, while in other embodiments, at least one component of the controller resides outside of the housing of the component of the gaming establishment fund management system, the component of the gaming establishment patron management system, and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the gaming establishment fund management system, the component of the gaming establishment patron management system, and/or the gaming establishment device. In certain embodiments, the at least one memory device resides within the housing of the component of the gaming establishment fund management system, the component of the gaming establishment patron management system, and/or the gaming establishment device, while in other embodiments at least one component of the at least one memory device resides outside of the housing of the component of the gaming establishment fund management system, the component of the gaming establishment patron management system, and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the gaming establishment fund management system, the component of the gaming establishment patron management system, and/or the gaming establishment device; (2) associations between configuration indicia read from the component of the gaming establishment fund management system, the component of the gaming establishment patron management system, and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the gaming establishment fund management system, the component of the gaming establishment patron management system, and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the gaming establishment fund management system, the component of the gaming establishment patron management system, and/or the gaming establishment device to control the component of the gaming establishment fund management system, the component of the gaming establishment patron management system, and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the gaming establishment fund management system, the component of the gaming establishment patron management system, and/or the gaming establishment device through any suitable data network described above (such as an Internet or intranet).

The at least one memory device also stores a plurality of device drivers. Examples of different types of device drivers include device drivers for the component of the gaming establishment fund management system, the component of the gaming establishment patron management system, and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the gaming establishment fund management system, the component of the gaming establishment patron management system, and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the gaming establishment fund management system, the component of the gaming establishment patron management system, and/or the gaming establishment device loads the new device driver from the at least one memory device to enable communication with the new device. For instance, one type of card reader in the component of the gaming establishment fund management system, the component of the gaming establishment patron management system, and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the gaming establishment fund management system, the component of the gaming establishment patron management system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the gaming establishment fund management system, the component of the gaming establishment patron management system, and/or the gaming establishment device. In various embodiments, the display devices serve as digital glass configured to aspects of the gaming establishment in which the component of the gaming establishment fund management system, the component of the gaming establishment patron management system, and/or the gaming establishment device is located. In various embodiments, the component of the gaming establishment fund management system, the component of the gaming establishment patron management system, and/or the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. In these embodiments, after the component of the gaming establishment fund management system, the component of the gaming establishment patron management system, and/or the gaming establishment device receives an actuation, the component of the gaming establishment fund management system, the component of the gaming establishment patron management system, and/or the gaming establishment device causes the payout device to provide a payment to the user. In certain embodiments, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. In another such embodiment, the component of the gaming establishment fund management system, the component of the gaming establishment patron management system, and/or the gaming establishment device provides dynamic sounds coupled with attractive multimedia images displayed on one or more of the display devices to provide an audio-visual representation or to otherwise display full-motion video with sound to attract users to the component of the gaming establishment fund management system, the component of the gaming establishment patron management system, and/or the gaming establishment device. In certain embodiments, the component of the gaming establishment fund management system, the component of the gaming establishment patron management system, and/or the gaming establishment device displays a sequence of audio and/or visual attraction messages during idle periods to attract potential users to the component of the gaming establishment fund management system, the component of the gaming establishment patron management system, and/or the gaming establishment device. The videos may be customized to provide any appropriate information.

The at least one input device may include any suitable device that enables an input signal to be produced and received by the at least one processor of the component of the gaming establishment fund management system, the component of the gaming establishment patron management system, and/or the gaming establishment device. In one embodiment, the at least one input device includes a payment device configured to communicate with the at least one processor of the component of the gaming establishment fund management system, the component of the gaming establishment patron management system, and/or the gaming establishment device to fund the component of the gaming establishment fund management system, the component of the gaming establishment patron management system, and/or the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the component of the gaming establishment fund management system, the component of the gaming establishment patron management system, and/or the gaming establishment device to be funded via an electronic funds transfer, such as a transfer of funds from a bank account. In another embodiment, the component of the gaming establishment fund management system, the component of the gaming establishment patron management system, and/or the gaming establishment device includes a payment device configured to communicate with a mobile device of a user, such as a mobile phone, a radio frequency identification tag, or any other suitable wired or wireless device, to retrieve relevant information associated with that user to fund the component of the gaming establishment fund management system, the component of the gaming establishment patron management system, and/or the gaming establishment device. When the component of the gaming establishment fund management system, the component of the gaming establishment patron management system, and/or the gaming establishment device is funded, the at least one processor determines the amount of funds entered and displays the corresponding amount.

In various embodiments, the at least one input device includes a plurality of buttons that are programmable by the component of the gaming establishment fund management system, the component of the gaming establishment patron management system, and/or the gaming establishment device operator to, when actuated, cause the component of the gaming establishment fund management system, the component of the gaming establishment patron management system, and/or the gaming establishment device to perform particular functions. For instance, such buttons may be hard keys, programmable soft keys, or icons icon displayed on a display device of the component of the gaming establishment fund management system, the component of the gaming establishment patron management system, and/or the gaming establishment device that are actuatable via a touch screen of the component of the gaming establishment fund management system, the component of the gaming establishment patron management system, and/or the gaming establishment device or via use of a suitable input device of the component of the gaming establishment fund management system, the component of the gaming establishment patron management system, and/or the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the component of the gaming establishment fund management system, the component of the gaming establishment patron management system, and/or the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the gaming establishment fund management system, the component of the gaming establishment patron management system, and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the gaming establishment fund management system, the component of the gaming establishment patron management system, and/or the gaming establishment device, such as one or more rechargeable power sources (e.g., rechargeable batteries) located at the component of the gaming establishment fund management system, the component of the gaming establishment patron management system, and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the gaming establishment fund management system, the component of the gaming establishment patron management system, and/or the gaming establishment device; detecting the presence and/or identity of various persons (e.g., users, casino employees, etc.), devices (e.g., user input devices), and/or systems within a predetermined proximity to the component of the gaming establishment fund management system, the component of the gaming establishment patron management system, and/or the gaming establishment device.

The at least one data preservation component is configured to detect or sense one or more events and/or conditions that, for example, may result in damage to the component of the gaming establishment fund management system, the component of the gaming establishment patron management system, and/or the gaming establishment device and/or that may result in loss of information associated with the component of the gaming establishment fund management system, the component of the gaming establishment patron management system, and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the gaming establishment fund management system, the component of the gaming establishment patron management system, and/or the gaming establishment device to operate in a mobile environment.

The at least one geolocation module is configured to acquire geolocation information from one or more remote sources and use the acquired geolocation information to determine information relating to a relative and/or absolute position of the component of the gaming establishment fund management system, the component of the gaming establishment patron management system, and/or the gaming establishment device. For example, in one implementation, the at least one geolocation module is configured to receive GPS signal information for use in determining the position or location of the component of the gaming establishment fund management system, the component of the gaming establishment patron management system, and/or the gaming establishment device. In another implementation, the at least one geolocation module is configured to receive multiple wireless signals from multiple remote devices (e.g., component of the gaming establishment fund management system, the gaming establishment patron management system, the retail point-of-sale system and/or the gaming establishment devices, servers, wireless access points, etc.) and use the signal information to compute position/location information relating to the position or location of the component of the gaming establishment fund management system, the component of the gaming establishment patron management system, and/or the gaming establishment device.

The at least one user identification module is configured to determine the identity of the current user or current owner of the component of the gaming establishment fund management system, the component of the gaming establishment patron management system, and/or the gaming establishment device. For example, in one embodiment, the current user is required to perform a login process at the component of the gaming establishment fund management system, the component of the gaming establishment patron management system, and/or the gaming establishment device in order to access one or more features. Alternatively, the component of the gaming establishment fund management system, the component of the gaming establishment patron management system, and/or the gaming establishment device is configured to automatically determine the identity of the current user based on one or more external signals, such as an RFID tag or badge worn by the current user and that provides a wireless signal to the component of the gaming establishment fund management system, the component of the gaming establishment patron management system, and/or the gaming establishment device that is used to determine the identity of the current user. In at least one embodiment, various security features are incorporated into the component of the gaming establishment fund management system, the component of the gaming establishment patron management system, and/or the gaming establishment device to prevent unauthorized users from accessing confidential or sensitive information.

The at least one information filtering module is configured to perform filtering (e.g., based on specified criteria) of selected information to be displayed at one or more displays of the component of the gaming establishment fund management system, the component of the gaming establishment patron management system, and/or the gaming establishment device.

In various embodiments, the component of the gaming establishment fund management system, the component of the gaming establishment patron management system, and/or the gaming establishment device includes a plurality of communication ports configured to enable the at least one processor of the component of the gaming establishment fund management system, the component of the gaming establishment patron management system, and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the gaming establishment fund management system, the component of the gaming establishment patron management system, and/or the gaming establishment device has a support structure, housing, or cabinet that provides support for a plurality of the input devices and the output devices of the component of the gaming establishment fund management system, the component of the gaming establishment patron management system, and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor, cause the processor to:
responsive to a first gaming establishment activity associated with a user occurring at a first point in time:
determine, based on the first gaming establishment activity, a first gaming establishment account from a plurality of gaming establishment accounts associated with the user, and
cause a transfer of funds associated with at least one of the plurality of gaming establishment accounts other than the first gaming establishment account to the determined first gaming establishment account, and
responsive to a second gaming establishment activity associated with the user occurring at a second, subsequent point in time:
determine whether a second gaming establishment account associated with the second gaming establishment activity is different from the first gaming establishment account, and
responsive to the determination being that the second gaming establishment account is different from the first gaming establishment account, cause a transfer of funds associated with at least one of the plurality of gaming establishment accounts to the second gaming establishment account.

2. The system of claim 1, wherein the first gaming establishment activity occurs at a first gaming establishment site, the second gaming establishment activity occurs at a second, different gaming establishment site and the first gaming establishment account is associated with at least the first gaming establishment site.

3. The system of claim 2, wherein when the first gaming establishment activity and the second gaming establishment are the same gaming establishment activity, and the first gaming establishment account is associated with the second, different gaming establishment site, the first gaming establishment account and the second gaming establishment account are the same gaming establishment account.

4. The system of claim 2, wherein when the first gaming establishment activity and the second gaming establishment are the same gaming establishment activity and the first gaming establishment account is not associated with the second, different gaming establishment site, the first gaming establishment account and the second gaming establishment account are different gaming establishment accounts.

5. The system of claim 2, wherein when the first gaming establishment activity and the second gaming establishment are different gaming establishment activities, the first gaming establishment account and the second gaming establishment account are different gaming establishment accounts.

6. The system of claim 2, wherein when the first gaming establishment activity is associated with a first gaming establishment vertical, the second gaming establishment activity is associated with the first gaming establishment vertical, and the first gaming establishment account is associated with the second, different gaming establishment site, the first gaming establishment account and the second gaming establishment account are the same gaming establishment account.

7. The system of claim 2, wherein when the first gaming establishment activity is associated with a first gaming establishment vertical, the second gaming establishment activity is associated with the first gaming establishment vertical, and the first gaming establishment account is not associated with the second, different gaming establishment site, the first gaming establishment account and the second gaming establishment account are different gaming establishment accounts.

8. The system of claim 2, wherein when the first gaming establishment activity is associated with a first gaming establishment vertical, and the second gaming establishment activity is associated with a second, different gaming establishment vertical, the first gaming establishment account and the second gaming establishment account are different gaming establishment accounts.

9. A system comprising:
a processor; and
a memory device that stores a plurality of instructions that, when executed by the processor, cause the processor to:
responsive to a first gaming establishment activity anticipated to occur in association with a user:
determine, based on the first gaming establishment activity anticipated to occur, a first gaming establishment account from a plurality of gaming establishment accounts associated with the user, and
cause a transfer of funds associated with at least one of the plurality of gaming establishment accounts other than the first gaming establishment account to the determined first gaming establishment account, and
responsive to a second gaming establishment activity anticipated to occur in association with the user:
determine whether a second gaming establishment account associated with the second gaming establishment activity anticipated to occur is different from the first gaming establishment account, and
responsive to the determination being that the second gaming establishment account is different from the first gaming establishment account, cause a transfer of funds associated with at least one of the plurality of gaming establishment accounts to the second gaming establishment account.

10. The system of claim 9, wherein the first gaming establishment activity is anticipated to occur at a first gaming establishment site, the second gaming establishment activity is anticipated to occur at a second, different gaming establishment site and the first gaming establishment account is associated with at least the first gaming establishment site.

11. The system of claim 10, wherein when the first gaming establishment activity anticipated to occur and the second gaming establishment anticipated to occur are the same gaming establishment activity, and the first gaming establishment account is associated with the second, different gaming establishment site, the first gaming establishment account and the second gaming establishment account are the same gaming establishment account.

12. The system of claim 10, wherein when the first gaming establishment activity anticipated to occur and the second gaming establishment anticipated to occur are the same gaming establishment activity and the first gaming establishment account is not associated with the second, different gaming establishment site, the first gaming establishment account and the second gaming establishment account are different gaming establishment accounts.

13. A method of operating a system, the method comprising:
responsive to a first gaming establishment activity associated with a user occurring at a first point in time:
determining, by a processor and based on the first gaming establishment activity, a first gaming establishment account from a plurality of gaming establishment accounts associated with the user, and
causing a transfer of funds associated with at least one of the plurality of gaming establishment accounts other than the first gaming establishment account to the determined first gaming establishment account, and
responsive to a second gaming establishment activity associated with the user occurring at a second, subsequent point in time:
determining, by the processor, whether a second gaming establishment account associated with the second gaming establishment activity is different from the first gaming establishment account, and
responsive to the determination being that the second gaming establishment account is different from the first gaming establishment account, causing a transfer of funds associated with at least one of the plurality of gaming establishment accounts to the second gaming establishment account.

14. The method of claim 13, wherein the first gaming establishment activity occurs at a first gaming establishment site, the second gaming establishment activity occurs at a second, different gaming establishment site and the first gaming establishment account is associated with at least the first gaming establishment site.

15. The method of claim 14, wherein when the first gaming establishment activity and the second gaming establishment are the same gaming establishment activity, and the first gaming establishment account is associated with the second, different gaming establishment site, the first gaming establishment account and the second gaming establishment account are the same gaming establishment account.

16. The method of claim 14, wherein when the first gaming establishment activity and the second gaming establishment are the same gaming establishment activity and the first gaming establishment account is not associated with the second, different gaming establishment site, the first gaming establishment account and the second gaming establishment account are different gaming establishment accounts.

17. The method of claim 14, wherein when the first gaming establishment activity and the second gaming establishment are different gaming establishment activities, the first gaming establishment account and the second gaming establishment account are different gaming establishment accounts.

18. The method of claim 14, wherein when the first gaming establishment activity is associated with a first gaming establishment vertical, the second gaming establishment activity is associated with the first gaming establishment vertical, and the first gaming establishment account is associated with the second, different gaming establishment site, the first gaming establishment account and the second gaming establishment account are the same gaming establishment account.

19. The method of claim 14, wherein when the first gaming establishment activity is associated with a first gaming establishment vertical, the second gaming establishment activity is associated with the first gaming establishment vertical, and the first gaming establishment account is not associated with the second, different gaming establishment site, the first gaming establishment account and the second gaming establishment account are different gaming establishment accounts.

20. The method of claim 14, wherein when the first gaming establishment activity is associated with a first gaming establishment vertical, and the second gaming establishment activity is associated with a second, different gaming establishment vertical, the first gaming establishment account and the second gaming establishment account are different gaming establishment accounts.
